(19) United States
(12) Patent Application Publication
(10) Pub. No.: US 2013/0291734 A1
(43) Pub. Date: Nov. 7, 2013

(54) CARBON CANISTER WITH INTEGRATED FILTER

(71) Applicants: Jhun Lin, Novi, MI (US); Mark Edward Hipp, South Lyon, MI (US); Christopher Kersman, Brighton, MI (US)

(72) Inventors: Jhun Lin, Novi, MI (US); Mark Edward Hipp, South Lyon, MI (US); Christopher Kersman, Brighton, MI (US)

(73) Assignee: Ford Global Technologies, LLC, Dearborn, MI (US)

(21) Appl. No.: 13/461,318

(22) Filed: May 1, 2012

(51) Int. Cl. B01D 53/02; B29C 45/14

(52) U.S. Cl. 96/134; 264/279

(57) ABSTRACT

A fuel vapor recovery system for a vehicle having a fuel system and an internal combustion engine includes a carbon canister having an injection molded housing of unitary construction including a first chamber having a purge port configured for connection to the internal combustion engine and a recovery port configured for connection to the fuel system, a second chamber fluidly coupled to the first chamber, and a third chamber fluidly coupled to the second chamber and having a vent port configured for connection to atmosphere. The canister may include first and second integrated frustospherical filters extending into the first and third chambers, respectively, each having a first plurality of longer radial slots and a second plurality of shorter radial slots disposed between respective ones of the longer radial slots to provide desired flow through the slots while containing activated carbon pellets and having a geometry that improves manufacturing tool life.

### TECHNICAL FIELD

The present disclosure relates to a carbon canister having an integrated retainer filter/strainer with slots to facilitate vapor flow and enhanced injection molding tool life.

### BACKGROUND

Carbon canisters containing activated carbon have been used on automotive vehicles to reduce or prevent fuel vapors from the fuel tank escaping to atmosphere. The vapor storage canister is coupled to the vehicle fuel tank as well as the vehicle engine with a vent valve to atmosphere. The activated carbon pellets in the canister absorb fuel vapors from the fuel tank during refueling, as well as fuel vapors associated with diurnal temperature variation. The stored fuel vapors are periodically purged from the carbon pellets by passing air from atmosphere over the pellets to desorb the fuel, with the fuel vapor inducted by the engine and combusted during engine operation.

The activated carbon pellets are added to the canister during assembly. A permanent filter, such as a foam filter, may be used at each entry/exit port to retain the pellets and any small particles that may dislodge during assembly or subsequent operation. The size of each port is determined in conjunction with the filter characteristics to maintain a desired flow rate through the filter/port while accommodating some reduction in flow rate due to anticipated filter clogging. A decreased filter/port flow rate may result in incomplete purging, or require longer time to purge the stored fuel vapors during engine operation. It is desirable to reduce the number of components of the canister assembly while providing a filter that contains the activated carbon within the canister. In addition, the filter should provide efficient flow through load, purge, and vent ports to provide acceptable purge cycle times. The present disclosure recognizes that some prior integrated filter designs are acceptable for many applications, but may impact reliability and durability of injection mold tooling, and alternative designs may improve flow for more efficient purging.

### SUMMARY

A carbon canister for use in a vapor recovery system of a vehicle having an internal combustion engine and a fuel system includes a housing defining a cavity configured to hold activated carbon including a first chamber having a purge port and a recovery port, a second chamber fluidly coupled to the first chamber and to atmosphere, and a first integrated filter of unitary construction having a cylindrical portion connected to a first spherical frustum having a first plurality of longer radial slots interposed a second plurality of shorter radial slots. The filter may extend within the first chamber of the housing and may also include a third plurality of slots disposed in a generally flat portion of the first spherical frustum. The housing may include a second integrated filter of unitary construction having a cylindrical portion connected to a second spherical frustum having a fourth plurality of longer radial slots interposed a fifth plurality of shorter radial slots, the second integrated filter extending within the second chamber. The second integrated filter may include an eighth plurality of slots disposed in a generally flat portion of the second spherical frustum. The housing may also include a third integrated filter of unitary construction extending into the first chamber and having a generally cuboid shape with a sixth plurality of slots extending from four corresponding sides to a fifth side and a seventh plurality of slots in the fifth side. The housing may also include a third chamber disposed between the first and second chambers. The housing and integrated filters may be formed from a single material to provide a unitary construction, such as by injection molding, for example.

In one embodiment, a fuel vapor recovery system for a vehicle having a fuel system and an internal combustion engine includes a carbon canister having an injection molded housing of unitary construction including a first chamber having a purge port configured for connection to the internal combustion engine and a recovery port configured for connection to the fuel system, a second chamber fluidly coupled to the first chamber, and a third chamber fluidly coupled to the second chamber and configured for connection to atmosphere, the canister including first and second integrated frustospherical filters extending into the first and third chambers, respectively, and each having a first plurality of longer radial slots and a second plurality of shorter radial slots disposed between respective ones of the longer radial slots. The housing may also include a third integrated filter having a generally cuboid shape extending into the first chamber, the third integrated filter including a plurality of slots along each of four sides extending to a connected fifth side. The third integrated filter may also include a plurality of slots within the fifth side. Similarly, the first and second integrated filters may each include a plurality of slots within a flat portion of the filter. In one embodiment, the carbon canister comprises activated carbon pellets contained within the first, second, and third chambers, and the slots of the integrated filters are sized to contain the activated carbon pellets within the housing. The carbon canister may also include a bottom plate secured to the housing.

Various embodiments according to the present disclosure include a method of making a carbon canister that includes forming a housing defining a first chamber, a second chamber, and a third chamber, each having an integrated filter extending into a respective chamber with a generally flat terminus and having a first plurality of elongated slots around a periphery and a second plurality of elongated slots in the generally flat terminus. The method may include forming at least one integrated filter having a third plurality of elongated slots disposed between respective slots of the first plurality of elongated slots. In one embodiment, the method includes forming integrated filters extending into the first chamber and the third chamber that comprise spherical frustums. In one embodiment, the method includes forming the housing with integrated filters by injection molding.

Fuel vapor recovery systems incorporating a carbon canister having one or more integrated filters according to various embodiments of the present disclosure may provide a number of associated advantages. For example, the retainer integrated filter(s) at the inlet and outlet ports of the canister function to contain the carbon bed within the canister, while allowing for the adsorption and desorption of fuel vapors for selective storing and recovery, respectively. Forming of the integrated retainer filter with three-dimensional slot feature(s) as a unitary part of the canister shell or housing provides more open area for vapor flow to facilitate efficient vapor storage or loading of the activated carbon, and subsequent purging. The three-dimensional slots provide a better flow through the canister, which prevents plugging while still keeping the carbon bed intact.

To provide desired flow characteristics, the three-dimensional slot features are designed, in one embodiment, to maximize the openings on the three-dimensional surfaces to achieve the least flow restriction. As such, the integrated retainer filters include primary and secondary slot patterns on all geometries, which may include domes, cylinders, parabolas, and the like. The slots may be located on any of these geometries. Various embodiments include slots on a dome/cylindrical shape geometry with a primary pattern of slots having longer length slots spread on the overall three dimensional surface, and a secondary pattern having shorter length slots located between the longer slots nearer the wide side of the geometry to efficiently utilize all the space of the geometry for less restriction.

A carbon canister having an integrated three-dimensional filter with multiple slot patterns according to embodiments of the present disclosure may also extend tooling life. The combination of the spherical and linear geometries of the slot features according to various embodiments of the present disclosure provides a better lock-in interface between the injection molding cavity and the core of the mold tooling to facilitate improved stabilization and structure strength of the tool during the injection/filling of the mold. In particular, the primary and secondary slots through any spherical/cylindrical portions provide strength and allow more mold steel surface-to-surface contact area between the core and the cavity to better withstand the injection pressure difference that can be generated by an unbalanced filling. As a result, there is less deflection on the tool, which improves reliability and durability of the tooling.

### BRIEF DESCRIPTION OF THE DRAWINGS

FIG. 1 is a schematic of a fuel vapor recovery system having a canister with an integrated filter according to one embodiment of the present disclosure operating in a vapor recovery mode;

FIG. 2 is a schematic of a fuel vapor recovery system having a canister with an integrated filter according to one embodiment of the present disclosure operating in a purge mode;

FIG. 3 is an exterior perspective view of one embodiment of a canister housing or shell having integrated three-dimensional filters extending into corresponding chambers of the canister according to the present disclosure;

FIG. 4 is a top view of the housing embodiment of FIG. 3 illustrating integrated filters of a carbon canister;

FIG. 5 is a partial perspective view of the interior of the housing embodiment of FIG. 3 illustrating two of the integrated filters extending into the housing;

FIG. 6 is a cross-sectional view of a carbon canister having integrated three-dimensional filters according to various embodiments of the present disclosure; and

FIG. 7 is a diagram illustrating a method of forming a housing for a carbon canister having integrated filters according to one embodiment of the present disclosure.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

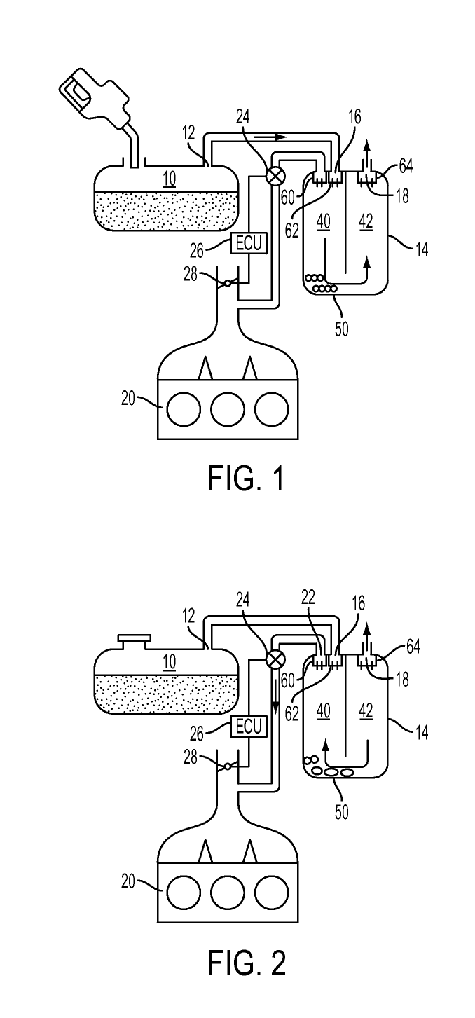

FIG. 1 is a schematic of a fuel vapor recovery system having a canister with an integrated filter according to one embodiment of the present disclosure operating in a vapor recovery mode. When an automotive fuel tank is filled, the fuel displaces the air/fuel vapor in the tank. To prevent those fuel vapors from entering the atmosphere, fuel tank 10 is provided with a fuel vent 12 coupled with a carbon canister 14 via recovery port 16. Carbon canister 14 is filled with activated carbon 50, which is retained within canister 14 by integrated filters/strainers/retainers 60, 62, and 64. As gases containing fuel vapor pass through the bed of carbon 50 within one or more chambers, such as first chamber 40 and second chamber 42, the fuel vapor is absorbed by the carbon pellets 50.

Carbon canister 14 also has a vent port 18 fluidly coupled to atmosphere. When gases exit carbon canister 14 through vent port 18, all, or substantially all, of the fuel has been removed from the gases displaced from the fuel tank and adsorbed by the carbon pellets 50. Vent port 18 may be coupled to a vent valve and to a coarse foam or media filter (not shown). The vent valve may be implemented by a controllable valve in communication with the vehicle/engine controller 26, or may be a passive or mechanically operated valve. The vent valve as well as purge valve 24 may be selectively opened and closed during various operating modes, such as a recovery (or vapor storage or loading) mode, purge mode, or diagnostic mode, for example.

A refueling operation is generally illustrated in FIG. 1, where the system is operating in a vapor recovery mode with valve 24 closed and the vent valve open. Vapor recovery may also occur when the vehicle is parked with a cap covering fuel tank 10. Daily or diurnal temperature variations may lead to lower molecular weight components of the fuel vaporizing during the heat of the day. The fuel vapors are then absorbed by carbon 50 within the canister 14. When the ambient temperature drops and gases in the system contract, fresh air enters through vent port 18.

Activated carbon has a limited ability to store fuel and is therefore periodically unloaded or purged as generally illustrated in FIG. 2. During unloading or purging, ECU 26 controls throttle valve 28 and purge valve 24 to create a vacuum to pull fresh air through vent port 18 and chambers 42 and 40 of canister 14 into an operating internal combustion engine 20 for combustion. The fuel vapors that are desorbed into the incoming air are then combusted in engine 20. The gases introduced through purge valve 24 are mixed with air entering the intake manifold through throttle valve 28.

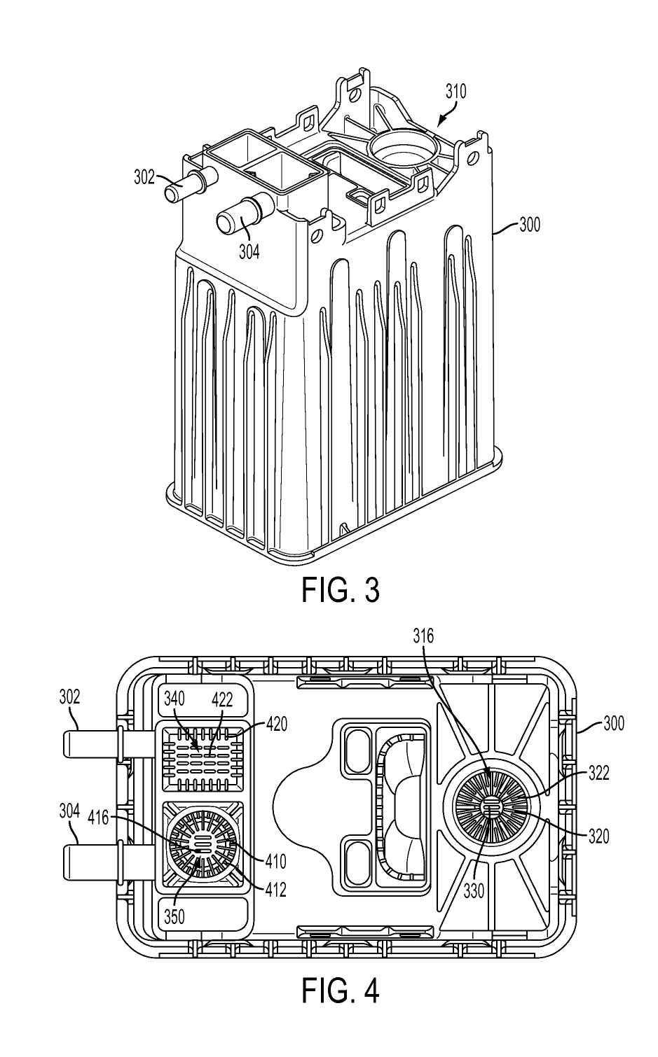

In one embodiment, a fuel vapor recovery system such as illustrated in FIGS. 1 and 2 for a vehicle having a fuel system including a fuel tank 10 and an internal combustion engine 20 includes a carbon canister 14 having an injection molded housing of unitary construction including a chamber 40 having a purge port 22 configured for connection to the internal combustion engine 20 and a recovery port 16 configured for connection to the fuel tank 10. The canister 14 also includes a chamber 42 fluidly coupled to chamber 40 and configured for connection to atmosphere. Canister 14 further includes first 60 and second 64 integrated frustospherical filters extending into the chambers 40 and 42, respectively. As illustrated and described in greater detail with reference to FIGS. 3-6, the integrated filters 60, 64 may each include a first plurality of longer radial slots and a second plurality of shorter radial slots disposed between respective ones of the longer radial slots. Canister 14 may also include a third integrated filter 62 having a generally cuboid shape extending into the chamber 40 and including a plurality of slots along each of four sides extending to a connected fifth side.

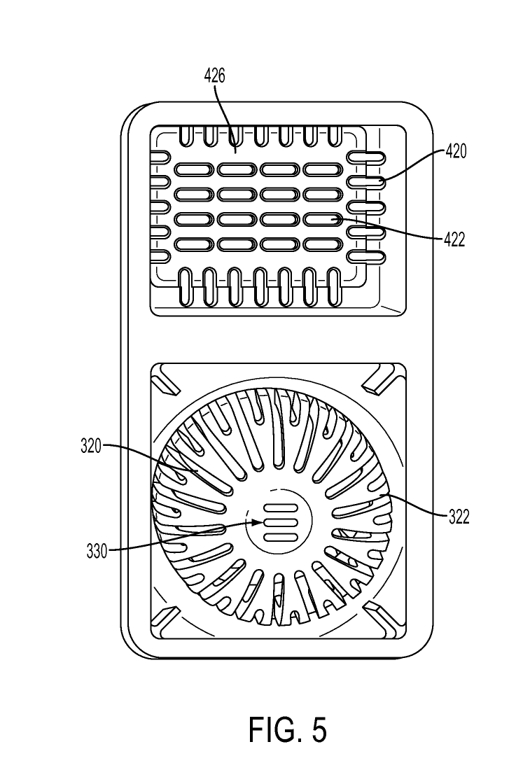

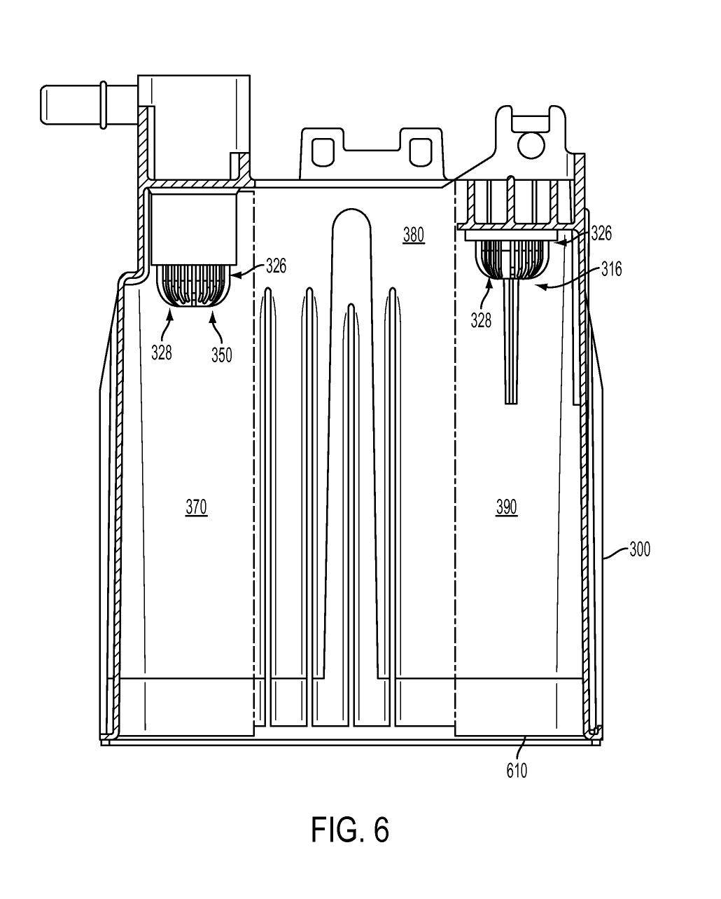

FIG. 3 is an exterior perspective view, FIG. 4 is a top view, FIG. 5 is an interior perspective view, and FIG. 6 is a cross-sectional view of one embodiment of a canister housing or shell having integrated three-dimensional filters extending into chambers of the canister according to the present disclosure. Housing 300 includes a purge port 302 having an associated integrated filter/retainer 340, and a load or recovery port 304 having an associated integrated filter 350, both of which extend into a first chamber 370 of housing 300. A vent port 310 has an associated integrated filter/retainer 316 that extends within a third chamber 390 of housing 300. Integrated filter 316 includes a first plurality of longer radial slots 320 extending around a periphery and disposed between or interposed a second plurality of shorter radial slots 322, which also extend around the periphery. A third plurality of slots 330 is disposed in a generally flat portion of integrated filter 316. In the embodiment illustrated, integrated filters 316 and 350 have three-dimensional geometries that are formed by a cylinder portion 326 coupled to a truncated hemispherical portion 328, also referred to as a spherical frustum or generally frusto-hemispherical in shape. As such, in this embodiment, a plurality of slots 330 is disposed within a generally flat portion of the spherical frustum. As best illustrated in FIG. 5, shorter radial slots 322 are formed primarily in the cylindrical portion, but may extend into the hemispherical portion of the filter between respective longer slots 320, which are formed primarily in the hemispherical portion, but may extend into the cylindrical portion. While the representative embodiment illustrated includes a hemispherical dome with two slot patterns, other three-dimensional geometries may be used, such as the cuboid geometry of integrated filter 340, for example. Similarly, other slot patterns and shapes may be used to provide a desired flow air and fuel vapors while retaining carbon bed 50 within housing 300. In various embodiments, the integrated retainer filters 316, 340, and 350 include primary and secondary slot patterns on various geometries, which may include domes, cylinders, parabolas, and the like. The slots may be located on any of these geometries.

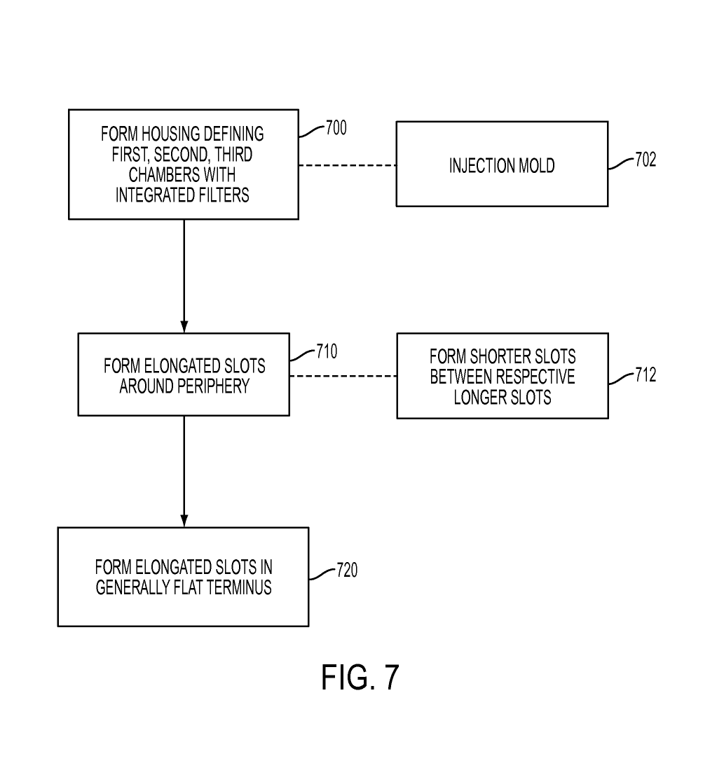

As generally illustrated in FIGS. 3-6, integrated filters 316, 340, and 350 are formed of unitary construction with housing 300. Integrated filters 316, 340, and 350 do not contain any foam or other filter media to retain carbon bed 50. As such, integrated filters 316, 340, and 350 provide various advantages with respect to increased air/vapor (fluid) flow and resist clogging by particles of carbon bed 50. As previously described, integrated filter 316 associated with vent port 310 may be used in combination with a separate removable media filter, such as a foam filter to reduce or prevent dirt or other debris from atmosphere from entering housing 300. As described in greater detail with respect to FIG. 7, housing 300 and integrated filters 316, 340, and 350 may be formed by injection molding. The arrangement, geometry, and size of slots, such as slots 320, 322, and 330, for example, are selected to improve injection molding tool life. For example, the combination of the spherical dome and linear cylinder geometries of the slot features according to various embodiments of the present disclosure provides a better lock-in interface between the injection molding cavity and the core of the mold tooling to facilitate improved stabilization and structure strength of the tool during the injection/filling of the mold. In particular, the primary and secondary slots through any spherical/cylindrical portions provide strength and allow more mold steel surface-to-surface contact area between the core and the cavity to better withstand the injection pressure difference that can be generated by an unbalanced filling. As a result, there is less deflection on the tool, which improves reliability and durability of the tooling.

As also shown in FIGS. 3-6, integrated filter 350 associated with vapor recovery port 304 is similar in construction to integrated filter 316 associated with vent port 310. As such, integrated filter 350 includes a first plurality of slots around a periphery, which includes longer elongated radial slots 410 and shorter elongated radial slots 412, as well as a plurality of slots 416 disposed in a terminus or generally flat portion of the hemispherical frustum or dome. As previously described, integrated filter 350, as well as integrated filters 316 and 350 extend within associated chambers of housing 300, or into the page as illustrated in FIGS. 4 and 6, and out of the page as illustrated in the partial interior perspective of FIG. 5. However, those of ordinary skill in the art will recognize that the three-dimensional filters may alternatively extend out of an associated chamber. Similarly, various combinations of integrated filters that extend into, or out of, housing 300 may be used depending on the particular application and implementation. However, the arrangement illustrated in FIGS. 3-6 provides various advantages with respect to injection molding and flow characteristics as described herein.

As best illustrated in FIGS. 4 and 5, integrated filter 340 associated with purge port 302 has a generally cuboid shape extending into first chamber 370 and includes a plurality of slots 420 along each of four sides extending to a connected fifth side, i.e. the generally flat top/bottom surface 426. Integrated filter 340 also includes a plurality of slots within the fifth side or surface 426. As best shown in FIG. 5, elongated slots 420 are spaced around the perimeter of integrated filter 340 and extend from respective sides to a face or surface 426. As previously described, the various slots of integrated filters 316, 340, and 350 are sized to contain or retain the activated carbon bed 50, which may be implemented by carbon pellets, for example. The carbon pellets or other carbon bed is placed within housing 300 during assembly and may be contained by a bottom plate 610 secured to housing 300. Various other components, such as pressure plates and springs, may be provided to closely pack the carbon pellets and reduce or eliminate noise from relative movement of pellets during vehicle operation.

As also illustrated in FIGS. 3-6, housing 300 may include a second chamber 380 disposed between and fluidly coupled to first chamber 370 and third chamber 390. In the representative embodiment illustrated, integrated filters 340 and 350 are associated with, and extend within first chamber 370, while integrated filter 316 is associated with, and extends within third chamber 390. Those of ordinary skill in the art will recognize that the present disclosure is generally independent of the number of chambers defined by housing 300, which may vary depending on the particular application and implementation.

FIG. 7 is a diagram illustrating a method of forming a housing for a carbon canister having one or more integrated filters according to one embodiment of the present disclosure. Those of ordinary skill in the art will recognize that various functions or procedures represented by separate blocks of FIG. 7 may be combined and performed substantially simultaneously in a single operation in some implementations. As such, the order illustrated is presented for ease of description and is a non-limiting example of a representative process. In the representative embodiment of a method of making a carbon canister, block 700 represents forming a housing defining a first chamber, a second chamber, and a third chamber, each having an integrated filter extending into an associated chamber with a generally flat terminus. As generally represented by block 702, forming of the canister housing may be performed by injection molding.

Block 710, which may be performed simultaneously during forming of the housing and integrated filters of a unitary construction as represented by block 700, may include forming a first plurality of elongated slots around a periphery of the filters. Block 710 may optionally include forming shorter elongated radial slots between respective longer elongated radial slots as represented by block 712. Block 720, which may be performed simultaneously during forming of the housing integrated filters as represented by block 700, may include forming a second plurality of elongated slots in the generally flat terminus. As previously described, one or more integrated filters may be formed such that each extends into the housing. In one embodiment, integrated filters are formed such that integrated filters extending into the first chamber and the third chamber of the housing comprise hemispherical frustums.

As demonstrated by the previously described and illustrated representative embodiments, fuel vapor recovery systems incorporating a carbon canister having one or more integrated filters(s) at the inlet and outlet ports of the canister function to contain the carbon bed within the canister, while allowing for the adsorption and desorption of fuel vapors for selective storing and recovery, respectively. Forming of the integrated retainer filter with three-dimensional slot feature(s) as a unitary part of the canister shell or housing provides more open area for vapor flow to facilitate efficient vapor storage or loading of the activated carbon, and subsequent purging. The three-dimensional slots provide a better flow through the canister, which prevents plugging while still keeping the carbon bed intact. In addition, a carbon canister having an integrated three-dimensional filter with multiple slot patterns according to embodiments of the present disclosure may also extend tooling life. In particular, the combination of hemispherical and linear/cylindrical geometries of the slot features according to various embodiments of the present disclosure provides a better lock-in interface between the injection molding cavity and the core of the mold tooling to facilitate improved stabilization and structure strength of the tool during the injection/filling of the mold. The primary and secondary slots through the spherical/cylindrical portions provide strength and allow more mold steel surface-to-surface contact area between the core and the cavity to better withstand the injection pressure difference that can be generated by an unbalanced filling. As a result, there is less deflection on the tool, which improves reliability and durability of the tooling.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which may depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are characterized as less desirable than other embodiments or background art implementations with respect to one or more characteristics are not outside the scope of the disclosure and may be desirable for particular applications.

What is claimed is:

1. A carbon canister, comprising:
a housing defining a cavity configured to hold activated carbon including:
a first chamber having a purge port and a recovery port;
a second chamber fluidly coupled to the first chamber and to atmosphere; and
a first integrated filter of unitary construction having a cylindrical portion connected to a first spherical frustum having a first plurality of longer radial slots interposed a second plurality of shorter radial slots.

2. The carbon canister of claim 1 wherein the first integrated filter comprises a third plurality of slots disposed in a generally flat portion of the first spherical frustum.

3. The carbon canister of claim 1 wherein the first integrated filter extends within the first chamber.

4. The carbon canister of claim 3 further comprising:
a second integrated filter of unitary construction having a cylindrical portion connected to a second spherical frustum having a fourth plurality of longer radial slots interposed a fifth plurality of shorter radial slots, the second integrated filter extending within the second chamber.

5. The carbon canister of claim 4 further comprising:
a third integrated filter of unitary construction extending into the first chamber and having a generally cuboid shape with a sixth plurality of slots extending from four corresponding sides to a fifth side and a seventh plurality of slots in the fifth side.

6. The carbon canister of claim 4 further comprising an eighth plurality of slots disposed in a generally flat portion of the spherical frustum.

7. The carbon canister of claim 1 wherein the housing further includes a third chamber disposed between the first and second chambers.

8. The carbon canister of claim 1 wherein the housing is injection molded.

9. A fuel vapor recovery system for a vehicle having a fuel system and an internal combustion engine, comprising:
a carbon canister having an injection molded housing of unitary construction including a first chamber having a purge port configured for connection to the internal combustion engine and a recovery port configured for connection to the fuel system, a second chamber fluidly coupled to the first chamber, and a third chamber fluidly coupled to the second chamber and configured for connection to atmosphere, the canister including first and second integrated frustospherical filters extending into the first and third chambers, respectively, and each having a first plurality of longer radial slots and a second plurality of shorter radial slots disposed between respective ones of the longer radial slots.

10. The fuel vapor recovery system of claim 9 wherein the injection molded housing further includes a third integrated filter having a generally cuboid shape extending into the first chamber, the third integrated filter including a plurality of slots along each of four sides extending to a connected fifth side.

11. The fuel vapor recovery system of claim 10 wherein the third integrated filter includes a plurality of slots within the fifth side.

12. The fuel vapor recovery system of claim 9 wherein the first and second integrated filters each include a plurality of slots within a flat portion of the filter.

13. The fuel vapor recovery system of claim 12 wherein the injection molded housing further includes a third integrated filter extending into the first chamber, the third integrated filter having a cuboid shape with rounded edges and a plurality of slots spaced around a perimeter with another plurality of slots in one face.

14. The fuel vapor recovery system of claim 13 wherein the plurality of slots are spaced around a perimeter and extend from respective sides to the one face.

15. The fuel vapor recovery system of claim 9 wherein the carbon canister further comprises activated carbon pellets contained within the first, second, and third chambers, and wherein the slots of the first and second integrated filters are sized to contain the activated carbon pellets.

16. The fuel vapor recovery system of claim 9 wherein the carbon canister further comprises a bottom plate secured to the housing.

17. A method of making a carbon canister, comprising:
forming a housing defining a first chamber, a second chamber, and a third chamber, each having an integrated filter extending into an associated chamber with a generally flat terminus and having a first plurality of elongated slots around a periphery and a second plurality of elongated slots in the generally flat terminus.

18. The method of claim 17 wherein at least one of the integrated filters includes a third plurality of elongated slots disposed between the first plurality of elongated slots.

19. The method of claim 18 wherein integrated filters extending into the first chamber and the third chamber comprise spherical frustums.

20. The method of claim 17 wherein forming comprises injection molding.
